(19) United States
(12) Patent Application Publication
(10) Pub. No.: US 2025/0339808 A1
(43) Pub. Date: Nov. 6, 2025

(54) Method And System For Separating Carbon Dioxide From The Ambient Air

(71) Applicant: Volkswagen Aktiengesellschaft, Wolfsburg (DE)

(72) Inventors: Christian HEIMERMANN, Wolfsburg (DE); Marc RUEGGEBERG, Braunschweig (DE); Marcel WIEGEL, Gardelegen / OT Sachau (DE)

(73) Assignee: Volkswagen Aktiengesellschaft, Wolfsburg (DE)

(21) Appl. No.: 19/196,992

(22) Filed: May 2, 2025

(30) Foreign Application Priority Data
May 3, 2024 (DE) 102024112491.1

(51) Int. Cl. B01D 53/04; B01D 53/26

(52) U.S. Cl. CPC B01D 53/0454; B01D 53/26; B01D 2253/108; B01D 2257/504; B01D 2257/80

(57) ABSTRACT

The disclosure relates to a method for separating carbon dioxide from the ambient air. The method comprises determining current and/or future weather parameters at the location of the system, conveying an air flow of the ambient air into a first process chamber, wherein the air flow is dried in the first process chamber, adsorbing carbon dioxide from the dried air flow using a physisorbent in a second process chamber, desorbing the carbon dioxide adsorbed in the physisorbent, and storing the desorbed carbon dioxide in a storage unit. It is provided that the process times of the system, the performance parameters of the system, and/or the air flow through the system are adjusted depending on the current or future weather parameters.

### CROSS-REFERENCE TO RELATED APPLICATIONS

This application claims priority to German Patent Application DE 10 2024 112 491.1, filed on May 3, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for separating carbon dioxide from the ambient air and to a system for carrying out such a method.

Systems and methods for separating carbon dioxide from the ambient air are known to the inventors. Such separation can be carried out using the so-called “direct air capture” method, in which the carbon dioxide can be separated directly from the ambient air, stored, or fed to a further process. Carbon dioxide can be separated from the ambient air using different sorbents. Typically, chemisorbents and/or physisorbents are used to separate carbon dioxide. Amine-based chemisorbents have the problem of aging and degradation when the material comes into contact with oxygen at temperatures above approx. 60° C. This can occur during the desorption phase at temperatures of around 100° C. if countermeasures are not implemented, for example an inert atmosphere in the system using water vapor or other gases. These protective measures are laborious and expensive.

Physisorbents, such as zeolites, have the problem that the affinity of the sorbent material for water (vapor) is higher than for carbon dioxide, which means that the ambient air must first be dried before being fed to an adsorption chamber in which the zeolite material is arranged. Drying the air in this way is also laborious and expensive.

In order to achieve efficient separation of carbon dioxide from the ambient air, carbon dioxide separation systems may be operated using renewable energies, in particular hydropower, geothermal energy, wind power, or solar energy. Operation with hydropower or geothermal energy would be beneficial, since this can be provided continuously and reliably. However, the potential for generating energy from hydropower is limited to corresponding river courses and is already almost fully utilized in many regions, and therefore expansion of the use of hydropower is limited.

Solar energy and wind power can essentially be used regardless of location, but their use is limited by the orbit of the sun and/or the weather conditions at the site.

### SUMMARY

A need exists to improve the energy efficiency and yield of carbon dioxide in a carbon dioxide separating system using a sorbent material.

The need is addressed by the subject matter of the independent claim(s). Embodiments of the invention are described in the dependent claims, the following description, and the drawings.

### BRIEF DESCRIPTION OF THE DRAWINGS

FIG. 1 shows an example embodiment of a system for separating carbon dioxide from the ambient air, which has a drying unit, a sorption unit, and a storage unit.

FIG. 2 is a flow chart for an example method according to the teachings herein for separating carbon dioxide from the ambient air, taking into account weather parameters.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for separating carbon dioxide from the ambient air in a system for separating carbon dioxide from the ambient air is provided. The method may comprise:
determining current and/or future weather parameters at the location of the system,
conveying an air flow of the ambient air into a first process chamber, wherein the air flow is dried in the first process chamber,
adsorbing carbon dioxide from the dried air flow using a physisorbent in a second process chamber,
desorbing the carbon dioxide adsorbed in the physisorbent, and
storing the desorbed carbon dioxide in a storage (unit).

According to the teachings herein, it is provided that the process times of the system, the performance parameters of the system, and/or the air flow through the system are adjusted depending on the current or future weather parameters.

The method according to the teachings herein makes it possible to adapt the output of the carbon dioxide separation system to the weather conditions prevailing at the site and thus increase the efficiency of the method. Knowledge of the weather data means that the amount of energy that can be made available via renewable energies such as wind power or solar power can be estimated and, if necessary, measures can be initiated to adjust the process control in the system accordingly in the event of unfavorable weather conditions and a lower expected amount of energy from renewable energies. Furthermore, the process control can also be adjusted with a sufficient amount of energy if the weather parameters are unfavorable for separating carbon dioxide, for example at high temperatures and a high relative humidity, which can extend the drying time of the air in the dryer, also referred to herein as ‘drying unit’.

The dependent claims discuss various embodiments.

In some embodiments, it is provided that the adjustment of the process times, the performance parameters, and/or the air flow is carried out depending on a forecast for the weather parameters for a defined forecast period. By taking into account the forecast data for a defined forecast period, system shutdowns can be planned, in particular for maintenance. The forecast period can range from a few hours to several days, for example from two hours to two weeks. In particular, a wind-powered system can react to an impending lull or a solar-powered system can react to a phase in which the sun does not shine or only rarely shines, when the electricity generated by the renewable energies is not or not completely sufficient to carry out the process with the optimum operating parameters. As an alternative to a shutdown, the process times in individual process steps/operations can also be adjusted in order to be able to react to a lower amount of energy.

In some embodiments, it is provided that the weather parameters include a wind direction and/or a wind strength at the location of the system. Detecting the wind direction and wind strength not only affects the amount of energy available from wind energy, but can also influence the air flow through the system. For example, the conveying capacity of the conveyor, also referred to herein as ‘conveying element’, can be adjusted depending on the wind direction and wind strength in order to adapt the air flow through the process chambers of the system to the weather conditions prevailing at the location of the system.

Alternatively or additionally and in some embodiments, it is possible that the weather parameters include a temperature at the location of the system. Since the ambient air can absorb more moisture as the temperature rises, the air temperature has a direct influence on the drying process of the ambient air fed to the system. Furthermore, as the ambient temperature rises, less energy is required to heat the air, but more is needed to cool it down when required. Accordingly, the amount of energy required can be estimated depending on the ambient temperature and any other weather parameters and adjusted accordingly.

Furthermore, alternatively or additionally and in some embodiments, it is possible that the weather parameters include a relative humidity of the ambient air at the location of the system. Humidity strongly influences the efficiency of a physisorbent-based system for separating carbon dioxide from the ambient air. Accordingly, knowledge of the current and predicted humidity can be used to reduce the energy demand. For example, the adsorption times in the dryer are adjusted. For example, the drying process can be shortened and the adsorption time extended at low humidity. This allows the adsorption time to be extended in relation to the desorption time, which can increase the energy efficiency of the process as fewer energy-intensive desorption cycles are required.

For a solar-powered system, it is particularly beneficial if the weather parameters include a strength of the solar radiation and/or shading at the location of the system according to some embodiments. The amount of energy available from solar energy, in particular photovoltaics, depends not only on the time of day and year, but also on the intensity of the sun at the location of the system. For example, the sun is lower on the horizon at the same time of day in winter than in summer, which reduces the amount of energy available. Furthermore, the period from sunrise to sunset is shorter in winter than in summer, which further reduces the possible energy yield. Weather phenomena such as clouds also lead to a reduction in the amount of energy and can be estimated as part of a weather forecast, such that maintenance of the system can be planned during a period without direct solar radiation, for example.

In some embodiments, it is provided that the process times are adjusted by controlling closure elements, for example controllable openings, which close at least one of the process chambers. For optimum process control, the first process chamber for drying and the second process chamber for adsorbing carbon dioxide are usually fitted with closure elements in order to temporarily isolate the process chamber from the environment. This makes it easy to manipulate the air in the process chamber, in particular to heat or cool the air or the drying material and/or the sorbent material, or to lower the air pressure in the process chamber. By controlling the closing elements, the process time in the corresponding process chamber can be easily adjusted.

In some embodiments, it is provided that the process times are adjusted by adjusting the air flow through the system. For example, the ratio of energy-intensive desorption time to adsorption time can be reduced if less energy is available from renewable sources. If the air throughput is reduced, the maximum adsorption time is extended while the desorption time remains the same.

In some embodiments, it is provided that a power controller for a conveyor, also referred to herein as ‘conveying element’, for conveying the air flow through the system is adjusted. The conveying volume and/or the conveying speed of the conveying element, in particular a blower, can be adjusted via the power controller.

Alternatively or additionally and in some embodiments, it is provided that the heating output of the heating element is adjusted in one of the process chambers or in both process chambers. As heating up the process chambers is also energy-intensive, the heating output can be reduced if the amount of energy available from renewable energy sources is lower, which increases the process time. However, by reducing the heating output, the process can still be fully ensured by means of renewable energies, which means that additional carbon dioxide emissions can be avoided.

In some embodiments, it is provided that a process time of the desorption is extended in relation to the process time of the adsorption if the weather data indicate that a reduced amount of energy is available to supply the system from renewable energies.

In some embodiments, it is provided that the system is shut down if the weather data indicate that the energy required for process control cannot be provided by renewable energy from wind or solar power. It may be necessary to shut down the system if the operating parameters required for process control, in particular the process temperature for desorbing carbon dioxide, can no longer be achieved. By predicting such a shutdown on the basis of weather data, appropriate adjustments can be made, for example in personnel planning, such that costs can be reduced. Alternatively, the system can be maintained or repaired during such a shutdown phase such that the system is available again when the weather conditions allow for efficient operation from renewable energies.

In some embodiments, it is provided that the drying time in the dryer is shortened if the relative humidity of the ambient air or the water content of the ambient air exceeds a threshold value. Since physisorbents, in particular zeolites, have a higher affinity for water vapor than for carbon dioxide, sufficient drying of the ambient air is necessary to enable efficient separation of carbon dioxide in the first place. It may therefore be necessary to adjust the drying time in order to prevent ambient air with too high a residual moisture content from being fed to the second process chamber for the adsorption of carbon dioxide. A high relative humidity means that the air mass flow must be reduced and/or regeneration of the drying material must be initiated earlier in order to ensure sufficient dehumidification for the subsequent adsorption of carbon dioxide.

Some embodiments relate to a system for separating carbon dioxide from the ambient air, comprising:
a conveyor for conveying an air flow of the ambient air into a first process chamber, wherein the air flow is dried in the first process chamber,
a sorption unit, also referred to as ‘sorption enclosure’, for adsorbing carbon dioxide from the dried air flow using a physisorbent in a second process chamber, and for subsequently desorbing the carbon dioxide adsorbed in the physisorbent, and
a storage, also referred to as ‘storage unit’, for storing the desorbed carbon dioxide,
a weather forecast circuit, and
a processor, also referred to as ‘control unit’, wherein the processor is configured to carry out such a method.

The system according to the teachings herein makes it possible to adapt the output of the carbon dioxide separation system to the weather conditions prevailing at the site, thereby increasing the efficiency of the system. Knowledge of the weather data means that the amount of energy that can be made available via renewable energies such as wind power or solar power can be estimated and, if necessary, measures can be initiated to adjust the process control in the system accordingly in the event of unfavorable weather conditions and a lower expected amount of energy from renewable energies. Furthermore, the process control can also be adjusted with a sufficient amount of energy if the weather parameters are unfavorable for the separation of carbon dioxide, for example at high temperatures and high relative humidity, whereby the drying time of the air in the dryer can be shortened. Alternatively, in this example, the air mass flow can be reduced in order to introduce the same amount of water into the sorbent material for the same drying time.

In some embodiments of the system, it is provided that the first process chamber and/or the second process chamber have a bypass through which the air flow can be guided past the dryer and/or the sorption unit. Depending on the wind direction and strength, the wind may create an air flow that would result in the air flow being conveyed through the system at too high a speed. In this case, it may be beneficial if a bypass is provided on at least one of the process chambers, for example on both process chambers, in order to guide at least a partial flow of air past the sorption element or the drying unit and thus adjust the air volume. It is provided that the ambient air passing the first process chamber for drying is not fed to the second process chamber for the adsorption of carbon dioxide, as the moisture contained in the ambient air passing the first process chamber would interfere with the adsorption process in the second process chamber.

In some embodiments, it is provided that the system is connected to a wind turbine and/or a solar power system, which provides the electrical energy to power the system. In order to achieve particularly efficient separation of carbon dioxide from the atmosphere, the system is for example operated with renewable energies, which do not lead to any further carbon dioxide emissions during operation. Compared to other renewable energies such as hydropower, systems for generating electricity from wind and solar energy have the benefit that they can be used substantially regardless of location and therefore do not limit the potential location of the system, but rather can be erected at this location.

According to some embodiments, it is provided that the weather forecast circuit is connected via a data connection to an external data source which provides the weather data. By supplying the weather forecast circuit with external data, a particularly accurate forecast of the expected weather parameters is possible.

Alternatively or additionally and in some embodiments, it is beneficially provided that the weather forecast circuit comprises a sensor for humidity, for wind speed, for solar radiation, and/or a temperature sensor. This makes it easy to determine the current weather parameters on site and forecast future weather parameters.

In the embodiments described herein, the described components of the embodiments each represent individual features that are to be considered independent of one another, in the combination as shown or described, and in combinations other than shown or described. In addition, the described embodiments can also be supplemented by features other than those described.

Reference will now be made to the drawings in which the various elements of embodiments will be given numerical designations and in which further embodiments will be discussed.

Specific references to components, process steps, and other elements are not intended to be limiting. The FIGS. are schematic and not necessarily to scale.

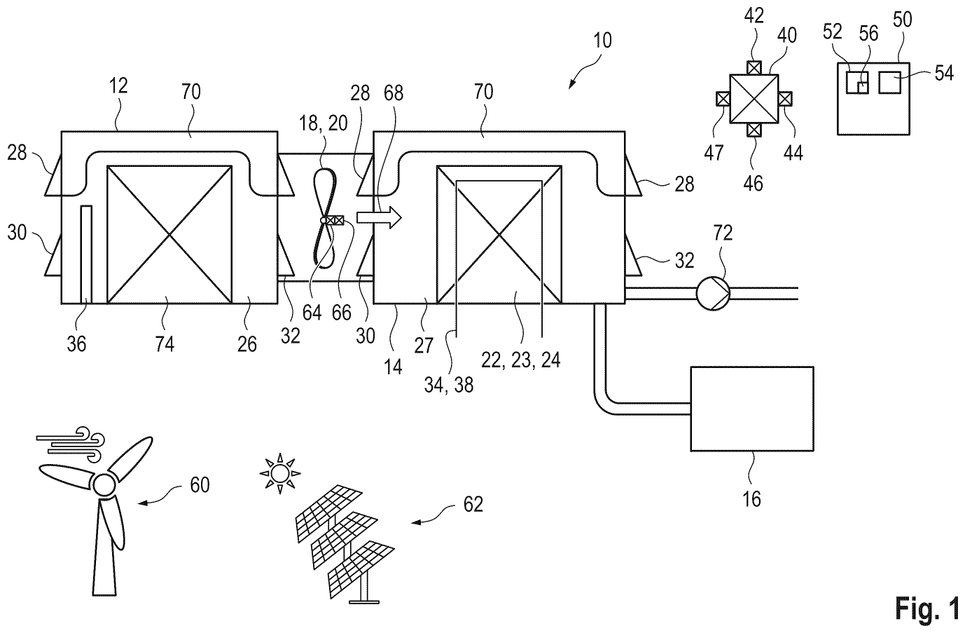

FIG. 1 shows a system 10 for separating carbon dioxide from the ambient air. Ambient air is fed to the system 10 and carbon dioxide and water are removed from this air. An exhaust air flow flows out of the system 10, which is dry and reduced in terms of carbon dioxide compared to the incoming air. The system 10 comprises a drying unit 12, in which the moisture contained in the ambient air is at least partially removed from the air flow 68. For example, a hydrophilic material such as silica gel can be used as the drying material 74 for the drying unit. In principle, any drying material that is suitable for absorbing moisture from the air can be used. For example, a drying material which can be regenerated and fed back to the process after absorbing the moisture by means of appropriate process control is used. The aim is to achieve a degree of drying of the ambient air at which the residual moisture in the air has a dew point of at most −30° C., or for example −50° C., or for example at most −60° C. dew point. The system 10 also comprises a sorption unit 14, in which the carbon dioxide from the ambient air is bound. The carbon dioxide 48 present in the dried ambient air is stored in a sorbent material 22, in particular in a physisorbent 23, for example in a zeolite material 24.

In addition, the system 10 has a storage unit 16, in which the carbon dioxide 48 separated from the ambient air in the sorption unit 14 is stored in concentrated form. The system 10 further comprises at least one conveying element 18, in particular a blower 20, by means of which an air flow of ambient air is guided through the drying unit 12 and then through the sorption unit 14.

The air is for example dried in a first process chamber 26, which may be separated from the environment in a substantially gas-tight manner by closure elements 28, in particular by flaps 30, 32. In the exemplary embodiment shown, the first process chamber 26 has two inlet flaps 30 and two outlet flaps 32. Furthermore, a bypass 70 is provided in order to be able to guide a gas flow past the drying material 74. This gas flow through the bypass is then discharged back into the environment in order to avoid feeding humid air into a second process chamber 27 for the adsorption of carbon dioxide. A heating element 34 and/or a cooling element 36 may be arranged in the first process chamber 26 in order to manipulate the air temperature in the drying unit 12 or else in the first process chamber 26. In particular, a cooling element 36 may be provided for cooling the air after drying in order to enable the most efficient possible adsorption of carbon dioxide in a subsequent process step.

The adsorption and subsequent desorption of carbon dioxide for example takes place in a second process chamber 27, which may be separated from the environment in a substantially gas-tight manner by means of closure elements 28, in particular flaps 30, 32. Furthermore, the second process chamber 27 has a heating element 34, in particular a heat exchanger 38, in order to be able to raise the temperature accordingly, in particular during the desorption process, and to release the carbon dioxide 48 adsorbed in the sorbent material 22. The second process chamber 27 or else the sorption unit 14 may also have a bypass 70 in order to guide an air flow 68 of ambient air past the sorbent material 22 and discharge it back into the environment.

Furthermore, a vacuum pump 72 may be arranged at the second process chamber 27 in order to manipulate the air pressure in the second process chamber 27 and, in particular, to lower it during a desorption process. The second process chamber 27 is fluidically connected to the storage unit 16, in which the carbon dioxide 48 separated from the ambient air can be stored. The vacuum pump 72 may also be arranged in the line between the second process chamber 27 and the storage unit 16 in order to extract the carbon dioxide 48 released during the desorption process from the second process chamber 27 and feed it to the storage unit 16.

A conveying element 18, in particular a blower 20, is provided between the drying unit 12 and the sorption unit 14 in order to convey an air flow 68 of the ambient air first through the drying unit 12 and then through the sorption unit 14. The conveyor element 18 has a drive unit 64, the power of which can be adjusted accordingly via a power controller 66.

The system 10 further comprises a weather forecast circuit 40, which may comprise various sensors 42, 44, 46, 47 for recording current weather data. FIG. 1 shows a weather forecast circuit which has a sensor 42 for detecting the humidity, a sensor 44 for detecting the wind speed, a sensor 46 for detecting the solar radiation, and a temperature sensor 47. The weather forecast circuit 40 may further be connected to an external data source 78 via a data connection 76 in order to transmit and/or receive weather data to improve the forecasting of the weather parameters.

The system 10 is for example supplied with electricity from renewable energy sources such as wind or solar power, so as not to generate any additional carbon dioxide emissions during operation. For this purpose, a wind turbine 60 and/or a solar power system 62, in particular a photovoltaic system, is provided in order to supply the system 10 with renewable energy.

The system 10 further has a control unit 50 having a memory unit 52 and a computing unit 54, wherein a computer program code 56 is stored in the memory unit 52, which computer program code is configured, when executed by the computing unit 54 of the control unit 50, to control the operation of the system 10 for separating carbon dioxide 48 from the ambient air.

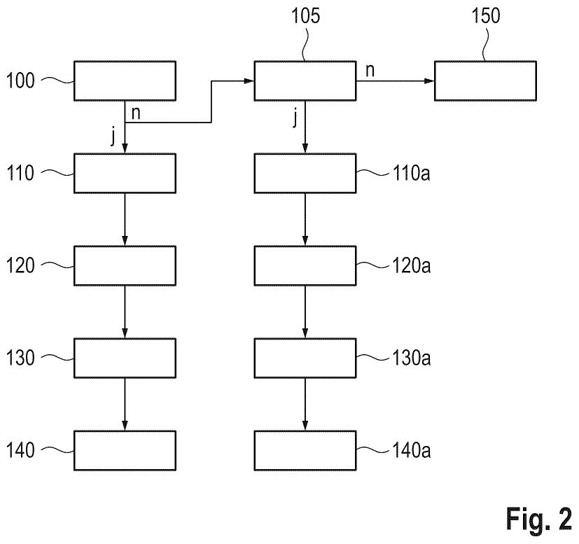

FIG. 2 is a flow chart for carrying out a method for separating carbon dioxide 48 from the ambient air. In a first method step <100>, current and/or future weather parameters are determined at the location of the system. Such weather data may include, in particular, humidity, wind direction and/or wind strength, temperature, duration and intensity of solar radiation, and other environmental parameters at the location of the system 10. If the current weather data and the weather data to be expected in the near future, in particular in the next few hours, permit undisturbed operation of the system 10, an air flow 68 of the ambient air is conveyed into a first process chamber 26 of the system 10 in a method step <110>, wherein the air flow 68 is dried in the first process chamber 26 by means of the drying material 74. In a method step <120>, carbon dioxide 48 is then adsorbed from the dried air flow 68 using a physisorbent 23 in a second process chamber 27.

In a process step <130>, the carbon dioxide 48 adsorbed in the physisorbent 23 is desorbed, wherein the carbon dioxide is discharged into the second process chamber 27.

In a process step <140>, the carbon dioxide 48 desorbed in the second process chamber 27 is evacuated from the second process chamber 27 and stored in a storage unit 16. This process step <140> can take place parallel to or following the process step <130>.

If, based on the current and/or expected weather parameters recorded in the process step <100>, it is to be expected that the output of the renewable energy sources 60, 62 cannot provide the electrical energy required for normal operation of the system, it is checked in a method step <105> whether efficient operation of the system 10 is possible with adjusted operating parameters. If this is not possible, the system 10 is shut down in a method step <150>, wherein the shutdown can be used to carry out maintenance or repair work on the system 10. Furthermore, planned shutdowns can be taken into account in personnel planning so that personnel costs and the associated operating costs of the system 10 can be reduced.

If operation with adjusted operating parameters is possible, an air flow 68 of the ambient air is conveyed into a first process chamber 26 of the system 10 in a method step <110a>, wherein the air flow 68 is dried by means of the drying material 74 in the first process chamber 26. In this way, the air volume of the air flow 68 through the system 10 can be adjusted, in particular to adjust the process times. For example, if less energy is available, it is helpful to reduce the ratio of energy-intensive desorption time to adsorption time. If the air throughput is reduced, the maximum adsorption time is extended while the desorption time remains the same.

Since humidity has a significant influence on process control, knowledge of the current and predicted humidity can be used to reduce the energy demand. In this way, the drying process of the air can be extended relative to the desorption time at low humidity, which increases the energy efficiency of the process. Alternatively, the drying time can be extended in the method step <110a> if less energy is available for drying the air flow 68 in order to ensure sufficient drying of the air for the subsequent adsorption process by means of the physisorbent 23.

In a method step <120a>, carbon dioxide 48 is then adsorbed from the dried air flow 68 using a physisorbent 23 in a second process chamber 27. If less energy is available, it is helpful to reduce the ratio of energy-intensive desorption time to adsorption time. The adsorption time for taking up the carbon dioxide 48 is for example kept constant and the desorption time is extended accordingly. If the duration of the processes in the first process chamber 26 and in the second process chamber 27 is to remain synchronized, the air mass flow can alternatively be reduced such that both the adsorption time and the desorption time or else the drying time can be extended.

In a method step <130a>, the carbon dioxide 48 adsorbed in the physisorbent 23 is desorbed, wherein the carbon dioxide 48 is discharged into the second process chamber 27. If less energy is available, the second process chamber 27 can be heated less quickly and/or a negative pressure can be generated in the second process chamber 27. It is therefore beneficial to extend the desorption time accordingly with a constant adsorption time in order to obtain a sufficient yield of carbon dioxide 48.

In a method step <140a>, the carbon dioxide 48 desorbed in the second process chamber 27 is evacuated from the second process chamber 27 and stored in a storage unit 16.

### LIST OF REFERENCE NUMERALS

10 System for separating carbon dioxide
12 Dryer (Drying unit)
14 Sorption unit (Sorption enclosure)
16 Storage (Storage unit)
18 Conveyor (Conveying element)
20 Blower
22 Sorbent material
23 Physisorbent
24 Zeolite
26 First process chamber
27 Second process chamber
28 Closure element
30 Inlet flap
32 Outlet flap
34 Heating element (Heater)
36 Cooling element (Cooler)
38 Heat exchanger
40 Weather forecast circuit
42 Sensor for humidity
44 Sensor for wind speed
46 Sensor for solar radiation
47 Temperature sensor
48 Carbon dioxide
50 Processor (Control apparatus)
52 Storage unit
54 Computer (Computing unit)
56 Computer program code
60 Wind turbine
62 Solar system
64 Drive unit
66 Power controller
68 Air flow
70 Bypass
72 Vacuum pump
74 Drying material
76 Data connection
78 Data source

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for separating carbon dioxide from the ambient air in a system for separating carbon dioxide, the method comprising:
determining current and/or future weather parameters at the location of the system;
conveying an air flow of the ambient air into a first process chamber, wherein the air flow is dried in the first process chamber;
adsorbing carbon dioxide from the dried air flow using a physisorbent in a second process chamber;
desorbing the carbon dioxide adsorbed in the physisorbent; and
storing the desorbed carbon dioxide in a storage, wherein
the process times of the system, the performance parameters of the system, and/or the air flow through the system are adjusted depending on the current or future weather parameters.

2. The method of claim 1, wherein the adjustment of the process times, the performance parameters, and/or the air flow is carried out depending on a forecast for the weather parameters for a defined forecast period.

3. The method of claim 1, wherein the weather parameters include a wind direction and/or a wind strength at the location of the system.

4. The method of claim 1, wherein the weather parameters include a temperature at the location of the system.

5. The method of claim 1, wherein the weather parameters include a relative humidity of the ambient air at the location of the system.

6. The method of claim 1, wherein the weather parameters include a strength of the solar radiation and/or shading at the location of the system.

7. The method of claim 1, wherein the process times are adjusted by controlling closure elements which close at least one of the process chambers.

8. The method of claim 1, wherein the process times are adjusted by adjusting the air flow through the system.

9. The method of claim 1, wherein a power for a conveyor for conveying the air flow through the system is adjusted by the system.

10. The method of claim 1, wherein a process time of the desorption is extended in relation to the process time of the adsorption if the weather data indicate that a reduced amount of energy is available to supply the system from renewable energies.

11. The method of claim 1, wherein the system is shut down if the weather data indicate that the energy required for process control cannot be provided by renewable energy from wind or solar power.

12. A system for separating carbon dioxide from the ambient air, comprising:
a conveyor for conveying an air flow of the ambient air into a first process chamber, wherein the air flow is dried in the first process chamber;
a sorption unit for adsorbing carbon dioxide from the dried air flow using a physisorbent in a second process chamber, and for subsequently desorbing the carbon dioxide adsorbed in the physisorbent; and
a storage for storing the desorbed carbon dioxide;
a weather forecast circuit; and
a processor, wherein the processor is configured to carry out the method of claim 1.

13. The system for separating carbon dioxide of claim 12, wherein the first process chamber and/or the second process chamber have a bypass through which the air flow can be guided past a dryer and/or the sorption unit.

14. The system for separating carbon dioxide of claim 12, wherein the system is connected to a wind turbine and/or a solar power system, which provides electrical energy to power the system.

15. The system for separating carbon dioxide of claim 12, wherein the weather forecast circuit is connected via a data connection to an external data source which provides the weather data.

16. The method of claim 1, wherein a power for a conveyor for conveying the air flow through the system is adjusted by adjusting the heating output of the heating element.

17. The system for separating carbon dioxide of claim 12, wherein the adjustment of the process times, the performance parameters, and/or the air flow is carried out depending on a forecast for the weather parameters for a defined forecast period.

18. The system for separating carbon dioxide of claim 12, wherein the weather parameters include a wind direction and/or a wind strength at the location of the system.

19. The system for separating carbon dioxide of claim 12, wherein the weather parameters include a temperature at the location of the system.

20. The system for separating carbon dioxide of claim 12, wherein the weather parameters include a relative humidity of the ambient air at the location of the system.
